(19) United States
(12) Patent Application Publication
(10) Pub. No.: US 2017/0011847 A1
(43) Pub. Date: Jan. 12, 2017

(54) Manufacturing Method for Magnet and Magnet

(71) Applicant: JTEKT CORPORATION, Osaka (JP)

(72) Inventors: Takumi MIO, Kariya-shi (JP); Koji NISHI, Anjo-shi (JP); Yusuke KIMOTO, Kariya-shi (JP); Takashi TAMURA, Itami-shi (JP)

(73) Assignee: JTEKT CORPORATION, Osaka (JP)

(21) Appl. No.: 15/200,938

(22) Filed: Jul. 1, 2016

(30) Foreign Application Priority Data
Jul. 8, 2015 (JP) 2015-136590

(51) Int. Cl. H01F 41/02; B22F 1/02; B22F 1/00

(52) U.S. Cl. CPC H01F 41/0266; B22F 1/0014; B22F 1/007; B22F 1/02

(57) ABSTRACT

A manufacturing method for a magnet is provided which includes molding, under pressure, magnetic powder in a form of secondary particles resulting from aggregation of primary particles, to obtain a molding. A ratio of an average particle size of the primary particles to a maximum particle size of the secondary particles is 1:150 to 1:200. The magnet in the invention is manufactured by the manufacturing method for a magnet in the invention. The invention allows manufacture of the molding and the magnet in both of which the magnetic powder is densely compressed. The magnet has a high residual magnetic flux density.

### INCORPORATION BY REFERENCE

The disclosure of Japanese Patent Application No. 2015-136590 filed on Jul. 8, 2015 including the specification, drawings and abstract, is incorporated herein by reference in its entirety.

### BACKGROUND OF THE INVENTION

1. Field of the Invention

The invention relates to a manufacturing method for a magnet and a magnet.

2. Description of the Related Art

Japanese Patent Application Publication No. 2006-287044 (JP 2006-287044 A) describes a powdery compound for nanocomposite magnets containing magnetically isotropic rare-earth-based nanocomposite magnet powder and resin.

Japanese Patent Application Publication No. 2015-8200 (JP 2015-8200 A) discloses manufacture of a magnet containing magnetic powder of a hard magnetic substance formed of an R—Fe—N-based compound or an Fe—N-based compound containing a rare earth element as R. The manufacture involves pressurizing the magnetic powder a plurality of times using a mold to form a primary molding, and heating the magnetic powder at a temperature lower than a decomposition temperature of the magnetic powder to join surfaces of adjacent magnetic particles of the magnetic powder to form a secondary molding.

The compound described in JP 2006-287044 A is used for a bond magnet, and in the compound, magnetic particles of the magnetic powder are bound together such that the synthetic resin contains the magnetic powder. When the volume of the magnetic powder is defined to be 100 vol %, normal bonded magnets contain 40 vol % or more synthetic resin. Magnetic characteristics of the bonded magnet are determined by the rate of magnetic powder contained in the bonded magnet (the content of the magnetic powder). A reduced content of the magnetic powder degrades the magnetic characteristics of the bonded magnet. An increased content of the magnetic powder not only significantly degrades moldability of the magnet (moldability in injection molding) but also causes magnetic powder particles to be insufficiently fixed together, precluding the shape of the bonded magnet from being maintained. Therefore, for the bonded magnets, improvement of the magnetic characteristics (suppression of a decrease in residual magnetic flux density) is limited.

JP 2015-8200 A, which is a technique dealing with the above problem, improves the magnetic characteristics due to non-use of resin. However, in JP 2015-8200 A, voids are likely to remain in the primary molding formed by pressurizing the magnetic powder, and thus it is difficult to increase the density of a magnet manufactured. In other words, an increase in residual magnetic flux density of the magnet manufactured is limited.

### SUMMARY OF THE INVENTION

An object of the invention is to provide a manufacturing method for a magnet and a magnet that achieve a high residual magnetic flux density.

According to a first aspect of the invention, a manufacturing method for a magnet includes molding, under pressure, magnetic powder in a form of secondary particles resulting from aggregation of primary particles, to obtain a molding. The magnetic powder is configured such that a ratio of an average particle size of the primary particles to a maximum particle size of the secondary particles is 1:150 to 1:200.

In the manufacturing method for a magnet according to the first aspect, the molding is formed using the magnetic powder with the particle sizes of the primary particles and the secondary particles controlled. The magnetic powder contains reduced voids between the magnetic particles of the magnetic powder. Molding the magnetic powder having the reduced voids results in a dense molding. Therefore, the manufacturing method allows manufacturing a magnet with a high residual magnetic flux density.

According to a second aspect of the invention, a magnet is manufactured by the manufacturing method for a magnet as described in the first aspect.
The magnet according to the second aspect is manufactured by the above-described manufacturing method and has a high residual magnetic flux density.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a chart illustrating steps of a manufacturing method for a magnet in a first embodiment;

FIG. 2 is a diagram schematically depicting a pressurizing roller that crushes magnetic powder in the first embodiment;

FIG. 3 is a schematic diagram illustrating a step of mixing magnetic powder and a lubricant together in the first embodiment;

FIG. 4 is a schematic diagram illustrating a step of further mixing the magnetic powder and the lubricant together in the first embodiment;

FIG. 5 is a sectional view schematically illustrating that magnetic powder and a binder in the first embodiment are mixed together;

FIG. 6 is a schematic view illustrating a pressurizing step for the magnetic powder in the first embodiment in which the magnetic powder has not been pressurized;

FIG. 7 is a schematic view illustrating the pressurizing step for the magnetic powder in the first embodiment in which the magnetic powder has not been pressurized;

FIG. 8 is an enlarged view schematically depicting an arrangement state of magnetic powder forming a molding in the first embodiment;

FIG. 9 is an enlarged view schematically depicting a configuration of a magnet in the first embodiment;

FIG. 10 is a graph illustrating a relation between a particle size characteristic of magnetic powder and the density of a molding in the manufacturing method for a magnet in the first embodiment;

FIG. 11 is a chart illustrating steps of a manufacturing method for a magnet in a second embodiment;

FIG. 12 is a chart illustrating steps of a manufacturing method for a magnet in a third embodiment; and

FIG. 13 is a diagram illustrating a variation in temperature in a heat treatment step of the manufacturing method for a magnet in the third embodiment.

### DETAILED DESCRIPTION OF EMBODIMENTS

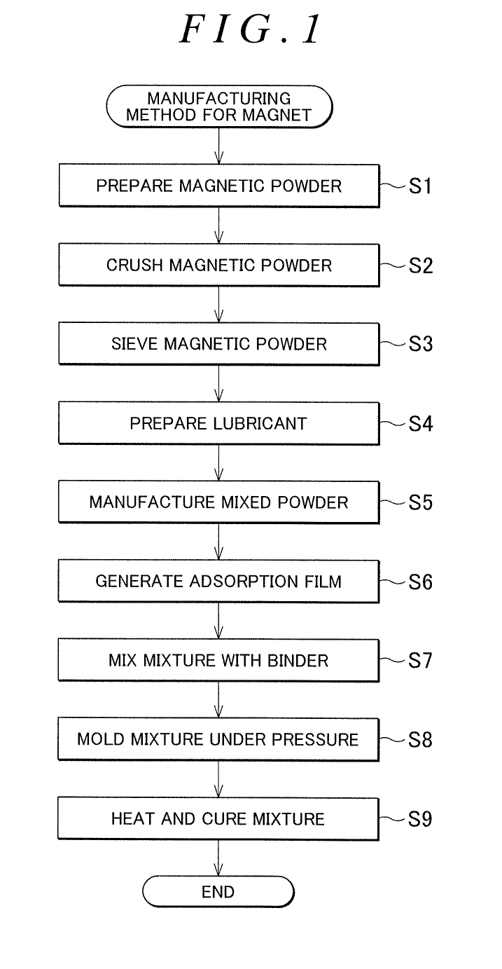

A manufacturing method for a magnet in the invention will be specifically described as an embodiment with reference to FIGS. 1 to 7. FIG. 1 is a chart illustrating steps of the manufacturing method for a magnet in the present embodiment.

As illustrated in step S1 in FIG. 1, magnetic powder 1 is prepared as a material for a magnet.

The magnetic powder 1 is powder that is an aggregate of particles of a magnetic material. The magnetic material for the magnetic powder 1 is not limited but is preferably a hard magnetic substance. Examples of the hard magnetic substance include a ferrite magnet, an Al—Ni—Co-based magnet, a rare earth magnet containing rare earth elements, and an iron nitride magnet.

As the magnetic powder 1 for the hard magnetic substance, a compound containing one or more of Fe—N-based compounds and R—Fe—N-based compounds (R: rare earth elements) is preferably used. The rare earth elements represented as R may be elements known as what is called rare earth elements (Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, and Lr) and are preferably rare earth elements other than Dy (R: rare earth elements other than Dy). Among these rare earth elements, light rare earth elements are particularly preferable. Among the light rare earth elements, Sm is most suitable. The light rare earth elements as used herein are elements included in lanthanoids and having a smaller atomic weight than Gd, that is, La to Eu. The Fe—N-based compound is contained in an iron nitride magnet. The R—Fe—N-based compound is contained in a rare earth magnet.

A specific composition of the magnetic powder 1 is not limited as long as the magnetic powder 1 contains the Fe—N-based compound or the R—Fe—N-based compound. The magnetic powder 1 is most preferably powder of Sm₂Fe₁₇N₃ or Fe₁₆N₂.

The particle size (average particle size) of the magnetic powder 1 is not limited. The average particle size (D50) is preferably approximately 2 to 5 μm. In the magnetic powder 1 used, an oxide film is not formed all over the surfaces of particles. The D50 as used herein means that the particles have a cumulative frequency of approximately 50 mass % in a particle size distribution.

As illustrated in step S2 in FIG. 1, the magnetic powder 1 is pressurized and crushed.

A method for crushing the magnetic powder 1 is not limited. For example, a pair of jigs is used to pressurize the magnetic powder 1 at a pressure equal to or higher than a burst pressure at which the magnetic powder 1 is destroyed. The pressure applied in the present embodiment is 1 to 3 GPa.

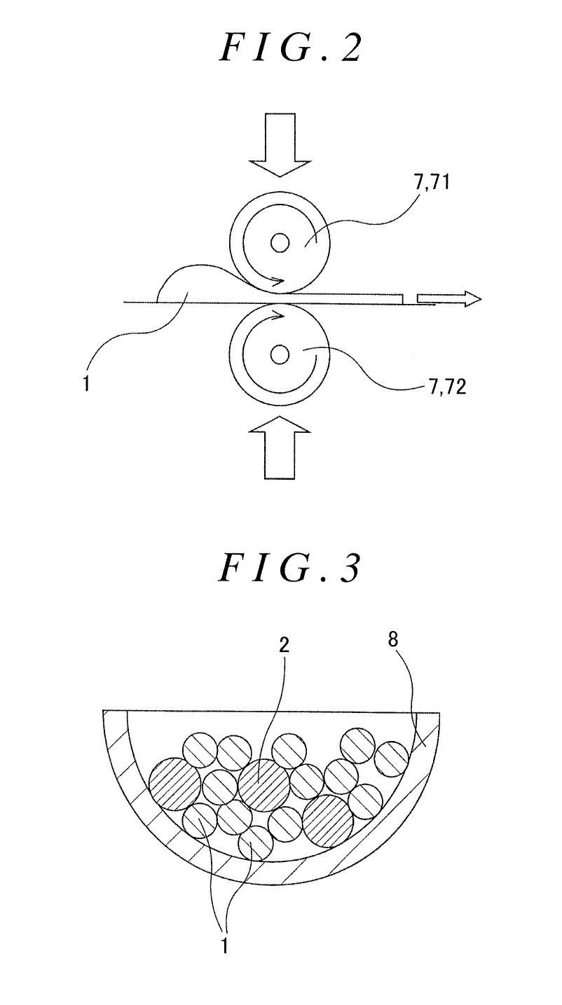

The pair of jigs is, for example, a pressurizing roller 7 depicted in FIG. 2. The pressurizing roller 7 includes an upper roller 71 and a lower roller 72. The magnetic powder 1 is passed under pressure between the rollers 71, 72. In the pressurization with the pressurizing roller 7 (71, 72), the above-described applied pressure is a linear load imposed during the pressurization. The pressurization with the pressurizing roller 7 (71, 72) can be achieved by reversing a feeding direction of the roller to repeat the pressurization.

In the present embodiment, the pressurization with the pressurizing roller 7 destroys the particles of the magnetic powder 1. In this case, one particle (first particle) of the magnetic powder 1 transmits a load to another magnetic particle (second particle) to destroy the second particle, which is subjected to the load that is equal to or higher than the burst pressure. The second particle is formed into fine crushed particles.

The magnetic powder 1 crushed by the pressurizing roller 7 is disintegrated. The crushed magnetic powder 1 is in a solid state in which the magnetic powder 1 has been compressed by the pressurization with the pressurizing roller 7. The disintegration changes the magnetic powder 1 into fine powder. At this time, primary particles of the magnetic powder 1 are aggregated into secondary particles. The aggregation of the primary particles results from adhesion of fine particles and the effect of a magnetic force of a magnet.

The magnetic powder 1 crushed in step S2 has an average particle size (D50) of 1.8 to 4.0 μm. The average particle size (D50) of the primary particles of the magnetic powder 1 can be measured by a well-known measuring method.

As illustrated in step S3 in FIG. 1, the crushed magnetic powder 1 is sieved.
The sieving is performed by passing the crushed magnetic powder 1 through a sieve with a predetermined mesh opening. The sieving is performed using a sieve with through-holes (mesh openings) that allow intended particles to be obtained.

The present embodiment uses the sieve for sieving of the magnetic powder. However, the invention is not limited to the sieve, and any method or apparatus can be used as long as the method or apparatus allows predetermined particles to be separated from the other particles. For example, particles with large particle sizes may be separated from the other particles using a classify apparatus such as an air sifter.

As described above, the magnetic powder 1 crushed in step S2 is formed into secondary particles. In step S3, the crushed magnetic powder 1 is sieved. That is, the magnetic powder 1 in the form of the secondary particles is sieved.

For the magnetic powder 1 sieved in step S3, the ratio of the average particle size (D50) of the primary particles to the maximum particle size of the secondary particles ranges from 1:150 to 1:200.

The ratio between the primary and secondary particles of the magnetic powder 1 falling within the above-described range reduces voids between the primary particles. The reduced voids between the primary particles enable a reduction in the amount of voids remaining in a molding resulting from pressurization of the magnetic powder 1 in a later pressurizing step (step S8). Accordingly, a magnet into which the molding is formed also has reduced voids and is thus dense.

When the consequent of the ratio is less than 150 and thus the ratio between the primary and secondary particles of the magnetic powder 1 falls outside the above range, moldability in pressurization is deteriorated. Specifically, the particle size of the secondary particles is excessively reduced to increase the number of secondary particles and the number of contact points between the secondary particles, leading to an increased apparent volume of the magnetic powder 1. During pressurization performed to form a molding, a large number of contact points are present between the secondary particles, which makes compression of the magnetic powder difficult.

When the consequent of the ratio is more than 200 and thus the ratio between the primary and secondary particles of the magnetic powder 1 falls outside the above range, voids remain in the molding (magnet). Specifically, the ratio falling outside the above range (the consequent is more than 200) causes particles with larger particle sizes to be contained in the magnetic powder 1. This makes voids likely to remain between the particles with large particle sizes. As a result, the voids remain in the molding resulting from pressurization of the magnetic powder 1.

The maximum particle size of the secondary particles of the magnetic powder 1 can be determined based on the mesh opening of the sieve used for sieving. In step S3, the secondary particles are sorted out using a sieve (30 mesh) with a mesh opening of 500 μm, and have a maximum particle size of 500 μm.

As illustrated in step S4 in FIG. 1, a lubricant 2 is prepared. The lubricant 2 is a substance that is solid (solid lubricant) under normal conditions (in an air atmosphere and at room temperature). As the lubricant 2, a powdery lubricant is used.

As the lubricant 2, a metal soap-based lubricant (solid lubricant powder) is used. The lubricant 2 is, for example, powder of stearic acid-based metal such as zinc stearate. The powder of the lubricant 2 has an average particle size (D50) of approximately 10 μm. The lubricant 2 preferably has a larger average particle size than the magnetic powder 1. The lubricant 2 has a smaller specific gravity than the magnetic powder 1. Consequently, when the size of the lubricant 2 is increased to some degree in an initial state, each particle of the lubricant 2 may have an increased mass, and thereby the lubricant 2 is precluded from scattering around during mixture in step S5 described below.

A mixing ratio between the magnetic powder 1 and the lubricant 2 may be optionally set. For the mixing ratio between the magnetic powder 1 and the lubricant 2, preferably, the mixed powder contains 80 to 90 vol % magnetic powder 1 and 5 to 15 vol % lubricant 2. Besides the magnetic powder 1 and the lubricant 2, an additive may be contained. Examples of the additive may include organic solvents that may be lost on subsequent heating.

As illustrated in step S5 in FIG. 1, the magnetic powder 1 and the lubricant 2 prepared in the above-described two steps are mixed together into mixed powder.

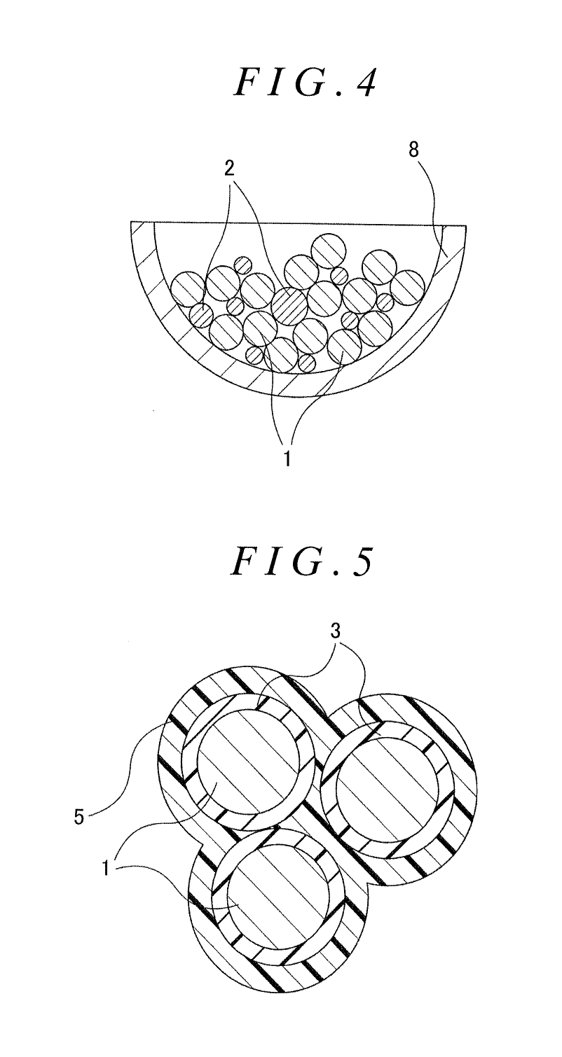

The magnetic powder 1 and the lubricant 2 are mixed together while being ground. A method for forming the mixed powder involves mixing the magnetic powder 1 and the lubricant 2 together while the magnetic powder 1 and the lubricant 2 are ground in a mixing container 8, as depicted in FIG. 3. When the magnetic powder 1 and the lubricant 2 are mixed together while being ground, the lubricant 2, which has a low binding strength, is fractionized to reduce its particle size as a whole, as depicted in FIG. 4. At the end of step S5, particles of the lubricant 2 with different sizes are present.

Formation of the mixed powder 1, 2 reduces aggregated portions containing only the magnetic powder 1 (disintegrates secondary particles of the magnetic powder 1), and reduces the size of the lubricant 2. In other words, particles of the lubricant 2 resulting from fractionization can be placed in proximity to the particles of the magnetic powder 1.

As illustrated in step S6 in FIG. 1, the mixed powder 1, 2 is heated to form an adsorption film 3 on the surface of the magnetic powder 1.
The mixed powder 1, 2 resulting from the mixture in the above-described step (step S5) is heated at a heating temperature T1 to form the adsorption film 3 of the lubricant 2 on the surface of the magnetic powder 1. At this time, the heating temperature T1 for the mixed powder 1, 2 is lower than a decomposition temperature T2 of the magnetic powder 1 and is equal to or higher than a melting point T3 of the lubricant 2 (T3≦T1<T2).

Heating the mixed powder 1, 2 at the heating temperature T1 causes the lubricant 2 to be melted without decomposition of the magnetic powder 1. The melted lubricant 2 flows along the surfaces of the particles of the magnetic powder 1 to coat the surface of the magnetic powder 1. The adsorption film 3 is then formed on the surface of the magnetic powder 1.

A heating time t at the heating temperature T1 depends on the amount of heat applied to the mixed powder 1, 2 and is not limited. In other words, the amount of heat applied to the mixed powder 1, 2 per unit time increases consistently with heating temperature T1, and thus the heating time t can be shortened. When the heating temperature T1 is relatively low, the heating time t is preferably extended.

In connection with the heating temperature T1 and the heating time t, an increase in the amount of heat applied to the mixed powder 1, 2 allows the adsorption film 3 to be more aggregately generated on the surface of the magnetic powder 1. This prevents the film from being broken during a pressurizing step, and a dense molding 5 and a dense magnet 6 can be manufactured.

As illustrated in step S7 in FIG. 1, an uncured binder 4 is placed on the surface of the magnetic powder 1 with the adsorption film 3 formed thereon.

As the binder 4, an uncured binder containing a silicone composition is used. The binder 4 is gelled or liquid at room temperature and is fluid. Mixing the magnetic powder 1 with the binder 4 allows the binder 4 to be placed on the surfaces (of the particles) of the magnetic powder 1. In this state, as depicted in a schematic sectional view in FIG. 5, the binder 4 is interposed between the adjacent particles of the magnetic powder 1.

The silicone composition in the binder 4 is a composition having a main framework based on siloxane bonding. The silicone composition is, for example, a silicone resin. The silicone composition is uncured (gelled or liquid) when placed on the surface of the magnetic powder 1 and is cured during the subsequent step (in the present embodiment, during thermal curing in step S9).

A method for curing the binder 4 is not limited. The method involves, for example, heating the binder 4, irradiating the binder 4 with ultraviolet rays, or bringing the binder 4 in contact with a reaction initiator such as water to start curing. The present embodiment uses a thermosetting silicone composition that is cured on heating.

The thermosetting silicone composition has a curing temperature (curing start temperature) T4 that is lower than the decomposition temperature T2 of the magnetic powder 1. The curing temperature (curing start temperature) T4 falling within this range restrains the magnetic powder 1 from being exposed to temperatures higher than T2 and prevents decomposition of the magnetic powder 1 or loss of the adsorption film 3.

The mixture rate of the binder 4 may be optionally set. For example, when the volume of the magnetic powder 1 (with the adsorption film 3 formed thereon) is defined to be 100 vol %, the mixed powder preferably contains 5 to 15 vol % binder 4 and more preferably 8 to 12 vol % binder 4.

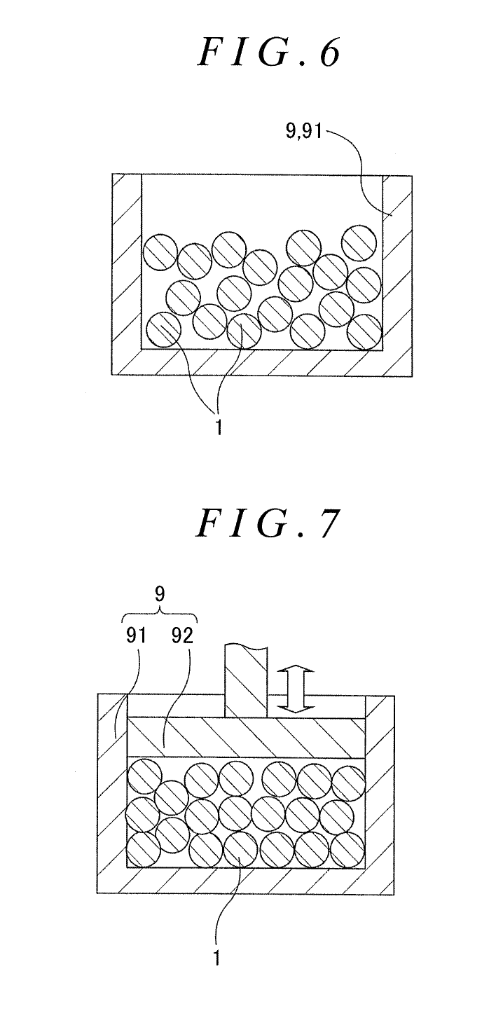

As illustrated in step S8 in FIG. 1, the magnetic powder 1 is pressurized to form a molding 5 (FIG. 6 and FIG. 7). In the magnetic powder 1 pressurized in the present step, the binder 4 is interposed between the particles.

In step S8, compression molding is performed using a pressurizing mold 9.

The pressurizing mold 9 includes a pressurizing lower mold 91 and a pressurizing upper mold 92. The magnetic powder 1 is molded under pressure by placing the magnetic powder 1 in a cavity in the pressurizing lower mold 91, assembling a pressurizing upper mold 92 on the pressurizing lower mold 91, and moving the pressurizing lower mold 91 and the pressurizing upper mold 92 in a direction in which the pressurizing lower mold 91 and the pressurizing upper mold 92 approach each other.

The pressurizing mold 9 is made from nonmagnetic steel. The pressurizing mold 9 includes a magnetic-field orienting apparatus not depicted in the drawings so that the magnetic powder 1 is pressurized under the condition that lines of magnetic force are transmitted through the magnetic powder 1 (under the condition for magnetic field orientation).
A release agent may be applied to an inner surface of the pressurizing mold 9. The composition of the release agent is not limited, and a well-known release agent may be used.

In the pressurizing step, as schematically illustrated in FIG. 6, the magnetic powder 1 is placed in a cavity in a pressurizing mold 9 (pressurizing lower mold 91). The pressurizing mold 9 is made from nonmagnetic steel. Pressurization of the pressurizing mold 9 is performed under the condition that lines of magnetic force are transmitted through the magnetic powder 1 (under the condition for magnetic field orientation).

Subsequently, as illustrated in a schematic diagram in FIG. 7, the magnetic powder 1 is molded under pressure using the pressurizing mold 9 (91, 92) by assembling the pressurizing upper mold 92 on the pressurizing lower mold 91 and moving the pressurizing lower mold 91 and the pressurizing upper mold 92 in a direction in which the pressurizing lower mold 91 and the pressurizing upper mold 92 approach each other. At this time, a pressure applied by the pressurizing mold 9 (91, 92) is equal to or lower than the burst pressure at which the magnetic powder 1 is destroyed. In the present embodiment, the pressure is 1 GPa or lower.

Pressurization using the pressurizing mold 9 (91, 92) is performed a plurality of times. After the pressure is applied to the pressurizing upper mold 92, the pressure applied to the pressurizing upper mold 92 is released, and then, a pressure is applied to the pressurizing upper mold 92 again. This operation is repeated. To release the pressure applied to the pressurizing upper mold 92, the pressurizing upper mold 92 may be moved upward or only the pressure applied to the pressurizing upper mold 92 may be reduced without upward movement of the pressurizing upper mold 92.
The pressurizing operations using the pressurizing mold 9 (91, 92) may be repeated until the density of the molding 5 plateaus. For example, the number of pressurizing operations may be two to 30.

Moreover, during the pressurizing step, the magnetic powder 1 in the pressurizing mold 9 (91, 92) may be heated by heating the pressurizing mold 9 (91, 92), for example, from an outer side surface thereof using a heater (not depicted in the drawings). At this time, a heating temperature T5 for the magnetic powder 1 is lower than the curing temperature T4 of the binder 4. The heating temperature T5 is also lower than the decomposition temperature T2 of the magnetic powder 1 (T3<T5<T4<T2). Therefore, the magnetic powder 1 is not decomposed and the binder 4 is also not cured even though they are heated.

Repeated pressurizing operations using the pressurizing mold 9 allow formation of a molding 5 having small clearances between the particles of the magnetic powder 1 as illustrated in the enlarged view in FIG. 8. This is because, during a plurality of pressurizing operations, the particles of the magnetic powder 1 are rearranged from the arrangement of the particles of the magnetic powder 1 resulting from the last pressurizing operation.

During the rearrangement of the particles of the magnetic powder 1, the particles of the magnetic powder 1 move very smoothly because the adsorption film 3 of the lubricant 2 is interposed between contact surfaces of the adjacent particles of the magnetic powder 1. The clearances between the particles of the magnetic powder 1 in the molding 5 are reduced in size by a synergistic effect of the rearrangement of the particles of the magnetic powder 1 and sliding attributed to the adsorption film 3.

The uncured binder 4 is also interposed between the particles of the magnetic powder 1. The uncured binder 4 exhibits characteristics similar to the characteristics of silicone oil and also exhibits lubricity. In other words, movement (rearrangement) of the particles of the magnetic powder 1 is promoted by the interposition of the adsorption film 3 and the uncured binder 4 between the adjacent particles of the magnetic powder 1. This action also serves to reduce the clearances in size between the particles of the magnetic powder 1 in the molding 5. That is, a molding 5 is obtained which has small clearances between the particles of the magnetic powder 1.

As illustrated in step S9 in FIG. 1, the molding 5 is heated to cure the binder 4.

The heating in the present step is performed by heating the molding 5 at a heating temperature T6. For example, the heating is performed by setting the temperature of the pressurizing mold 9 equal to the heating temperature T6 without extracting, from the pressurizing mold 9, the molding 5 obtained using the pressurizing mold 9 in the above-described pressurizing step.

Alternatively, the molding 5 may be extracted from the pressurizing mold 9 and placed in a microwave heating furnace, an electric furnace, a plasma heating furnace, an induction hardening furnace, a heating furnace using an infrared heater, or the like.
The heating at the heating temperature T6 lasts until curing of the binder 4 is completed.
The magnet 6 in the present embodiment is manufactured through the above steps.

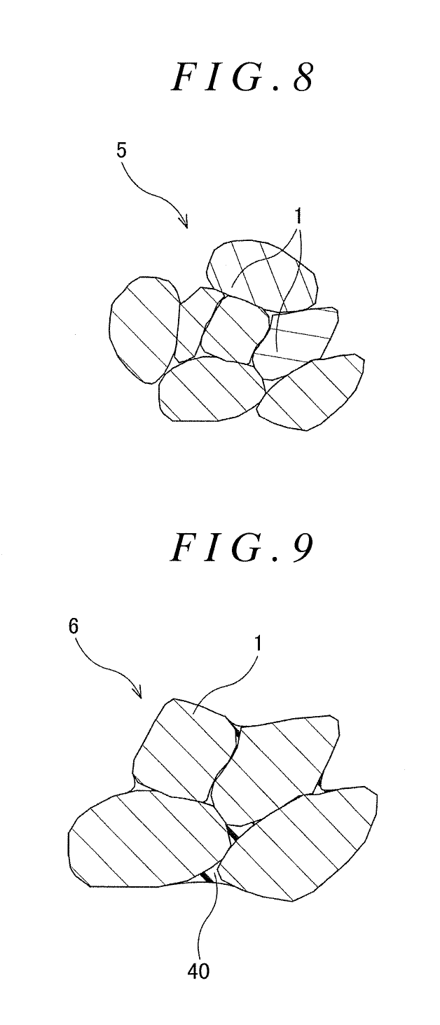

The magnet 6 in the present embodiment, the configuration of which is illustrated in a schematic diagram in FIG. 9, contains reduced voids between the particles of the magnetic powder 1 and is thus dense. In the magnet 6 in the present embodiment, a cured binder 40 binds the particles of the magnetic powder 1 together.

The binder 40 is interposed only near the contact portions of the particles of the magnetic powder 1. That is, the binder 40 is absent from a certain area of the surface of each of the particles of the magnetic powder 1. In this case, the adsorption film 3 is formed on the surface of the magnetic powder 1, restraining the magnetic material from being exposed. In other words, the magnetic characteristics of the magnetic powder 1 are restrained from being degraded by, for example, oxidation resulting from the atmosphere.

The effects of the present embodiment will be described using a specific example.

The magnetic powder 1 crushed in step S2 was sieved using sieves with different mesh openings. Thus, samples of the magnetic powder 1 were obtained which contained secondary particles with different maximum particle sizes. At this time, the average particle size (D50) of primary particles was the same for each of the particles.
Steps S4 to S9 were executed on the resultant samples of the magnetic powder 1 to obtain moldings 5.

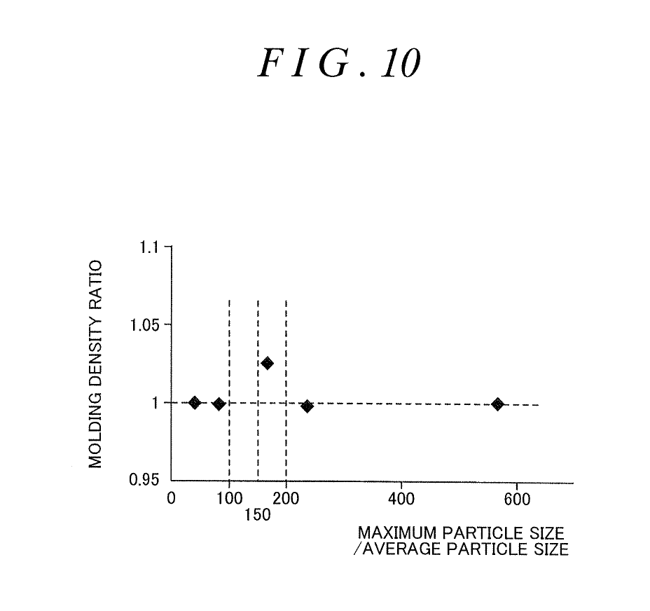

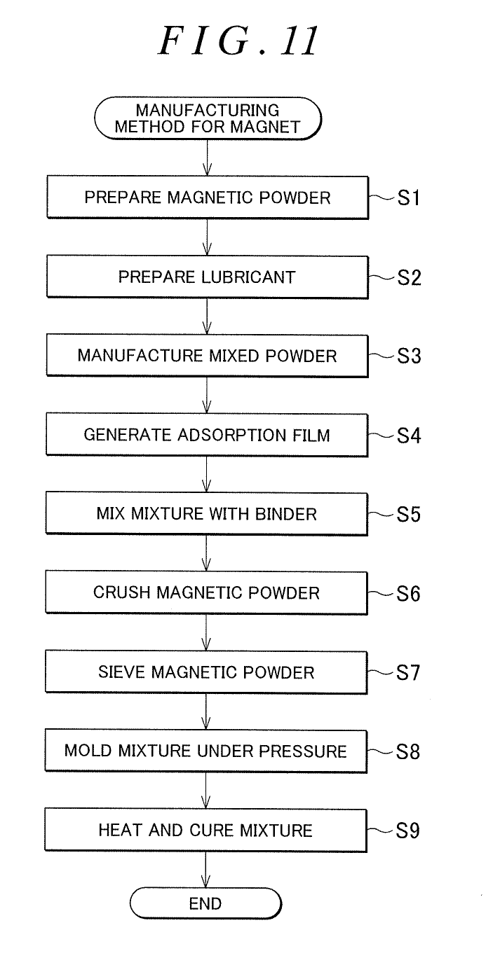

The resultant moldings 5 of the samples were measured for density to obtain molding density ratios, with the density of the molding 5 of the unsieved sample defined to be 1. FIG. 10 illustrates a relation between the molding density ratio and the ratio between the maximum particle size of the secondary particles of the magnetic powder 1 (the mesh opening length of the sieve) and the average particle size (D50) of the primary particles.

FIG. 10 indicates that, for the samples with a ratio between the maximum particle size and the average particle size falls in a range from 150 to 200, the moldings 5 have high densities. For the samples with a ratio between the maximum particle size and the average particle size falling outside this range, the moldings 5 exhibit no variation in density.

As described above in detail, when a ratio between the maximum particle size and the average particle size falls within the range from 150 to 200 (the ratio of the average particle size of the primary particles to the maximum particle size of the secondary particles ranges from 1:150 to 1:200), moldings 5 with high densities can be obtained.

In the manufacturing method in the present embodiment, the molding 5 is formed from the magnetic powder 1 with the particle sizes of the primary and secondary particles limited. A first effect of this configuration is a reduction of the voids between the particles of the magnetic powder 1, and thus a molding 5 in which the particles of the magnetic powder 1 are densely arranged can be obtained.

Specifically, the particle characteristic of the magnetic powder 1 is defined by the average particle size (D50) of the primary particles and the maximum particle size of the secondary particles. In the magnetic powder 1, the particle size of the secondary particles is reduced to prevent an increase the number of contact points between the secondary particles resulting from an increased number of secondary particles and also to prevent an increase in the amount of voids around the secondary particles resulting from an increased particle size of the secondary particles. Consequently, fine primary particles are positioned around the secondary particles, leading to a reduced amount (size) of the voids.
In the present embodiment, the magnetic powder 1 is molded under pressure into a molding 5. This compression molding allows the particles of the magnetic powder 1 to be rearranged to further reduce the voids between the particles.
As a result, the manufacturing method in the present embodiment allows a dense molding 5 to be obtained. Accordingly, it is possible to obtain a dense magnet 6 having reduced voids from the dense molding 5.

The manufacturing method in the present embodiment obtains the magnetic powder 1 by pressurizing magnetic powder 1 having a larger particle size than the primary particles at a pressure equal to or higher than the burst pressure to destroy the magnetic powder 1 and to form the secondary particles. A second effect of the present embodiment is that the magnetic powder 1 can be easily prepared by pressurizing (destroying) magnetic powder with large particles to obtain the magnetic powder 1.

In the manufacturing method in the present embodiment, the maximum particle size of the secondary particles is controlled by sieving. A third effect of the present embodiment is that the magnetic powder 1 with the desired particle size characteristic can be easily prepared by controlling the maximum particle size based on the mesh opening of the sieve.

The magnet 6 in the present embodiment is manufactured by the above-described manufacturing method. This configuration provides a magnet that produces the above-described first to third effects.

A manufacturing method for a magnet as a second embodiment of the invention will be described with reference to FIG. 11. FIG. 11 is a chart illustrating steps of the manufacturing method for a magnet in the present embodiment.

As illustrated in step S1 in FIG. 11, the magnetic powder 1 as a raw material for a magnet is prepared. The present step is similar to step Si in the first embodiment.
As illustrated in step S2 in FIG. 11, the lubricant 2 is prepared. The present step is similar to step S4 in the first embodiment.

As illustrated in step S3 in FIG. 11, the magnetic powder 1 and the lubricant 2 prepared in the above-described two steps are mixed together into mixed powder. The present step is similar to step S5 in the first embodiment.
As illustrated in step S4 in FIG. 11, the mixed powder 1, 2 is heated to form the adsorption film 3 on the surface of the magnetic powder 1. The present step is similar to step S6 in the first embodiment.

As illustrated in step S5 in FIG. 11, the uncured binder 4 is placed on the surface of the mixed powder 1, 2. The present step is similar to step S7 in the first embodiment.
As illustrated in step S6 in FIG. 11, the mixed powder 1, 2 is pressurized to crush the magnetic powder 1. The present step is similar to step S2 in the first embodiment.

Specifically, the pressurizing roller 7 (71, 72) is used to pressurize (press) the magnetic powder 1 at a pressure equal to or higher than the burst pressure at which the magnetic powder 1 is destroyed. The pressure applied in the present embodiment is also 1 to 3 GPa.
In the present embodiment as well, the pressurization with the pressurizing roller 7 destroys the particles of the magnetic powder 1. In this case, one particle (first particle) of the magnetic powder 1 transmits a load to another magnetic particle (second particle) to destroy the second particle, which is subjected to the load that is equal to or higher than the burst pressure. The second particle is formed into fine crushed particles.

The magnetic powder 1 crushed by the pressurizing roller 7 is disintegrated. The crushed magnetic powder 1 is in a solid state in which the magnetic powder 1 has been compressed by the pressurization with the pressurizing roller 7. The disintegration changes the magnetic powder 1 into fine powder. At this time, primary particles of the magnetic powder 1 are aggregated into secondary particles. The aggregation of the primary particles results from adhesion of fine particles and the effect of a magnetic force of a magnet.

The magnetic powder 1 crushed in step S6 has an average particle size (D50) of 1.8 to 4.0 μm. The average particle size (D50) of the primary particles of the magnetic powder 1 can be measured by a well-known measuring method.

As illustrated in step S7 in FIG. 11, the crushed magnetic powder 1 is sieved. The present step is similar to step S3 in the first embodiment.
Specifically, the sieving is performed using a sieve with through-holes that allow intended particles to be obtained.
The present embodiment also uses the sieve for sieving of the magnetic powder. However, the invention is not limited to the sieve, and any method or apparatus can be used as long as the method or apparatus allows predetermined particles to be separated from the other particles.

For the magnetic powder 1 sieved in step S7, the ratio of the average particle size (D50) of the primary particles to the maximum particle size of the secondary particles ranges from 1:150 to 1:200, as is the case with the first embodiment.

The ratio between the primary and secondary particles of the magnetic powder 1 falling within the above-described range reduces voids between the secondary particles. The reduced voids between the secondary particles enable a reduction in the amount of voids remaining in a molding resulting from pressurization of the magnetic powder 1 in a later pressurizing step. Accordingly, a magnet into which the molding is formed also has reduced voids and is thus dense.

When the consequent of the ration is less than 150 and thus the ratio between the primary and secondary particles of the magnetic powder 1 falls outside the above range, moldability in pressurization is deteriorated. Specifically, the particle size of the secondary particles is excessively reduced to increase the number of secondary particles and the number of contact points between the secondary particles, leading to an increased apparent volume of the magnetic powder 1. During pressurization performed to form a molding, a large number of contact points are present between the secondary particles, which makes compression of the magnetic powder difficult.

When the consequent of the ratio is more than 200 and thus the ratio between the primary and secondary particles of the magnetic powder 1 falls outside the above range, voids remain in the molding (magnet). Specifically, the ratio falling outside the above range (the consequent is more than 200) causes secondary particles with larger particle sizes to be contained in the magnetic powder 1. This makes voids likely to remain between the secondary particles with large particle sizes. As a result, the voids remain in the molding resulting from pressurization of the magnetic powder 1.

The maximum particle size of the secondary particles of the magnetic powder 1 can be determined based on the mesh opening of the sieve used for sieving. In step S7, the secondary particles are sorted out using a sieve (30 mesh) with a mesh opening of 500 μm, and have a maximum particle size of 500 μm.

As illustrated in step S8 in FIG. 11, the magnetic powder 1 is pressurized into a molding 5. The present step is similar to step S8 in the first embodiment.
As illustrated in step S9 in FIG. 11, the molding 5 is heated to cure the binder 4. The present step is similar to step S9 in the first embodiment.

Like the first embodiment, the present embodiment allows a dense molding 5 to be obtained. Accordingly, it is possible to obtain a dense magnet 6 from the dense molding 5.
That is, even though, with the mixed powder formed, the magnetic powder 1 is destroyed to form magnetic powder 1 with a particular particle size characteristic as in the present embodiment, a dense magnet 6 is effectively obtained as in the first embodiment.

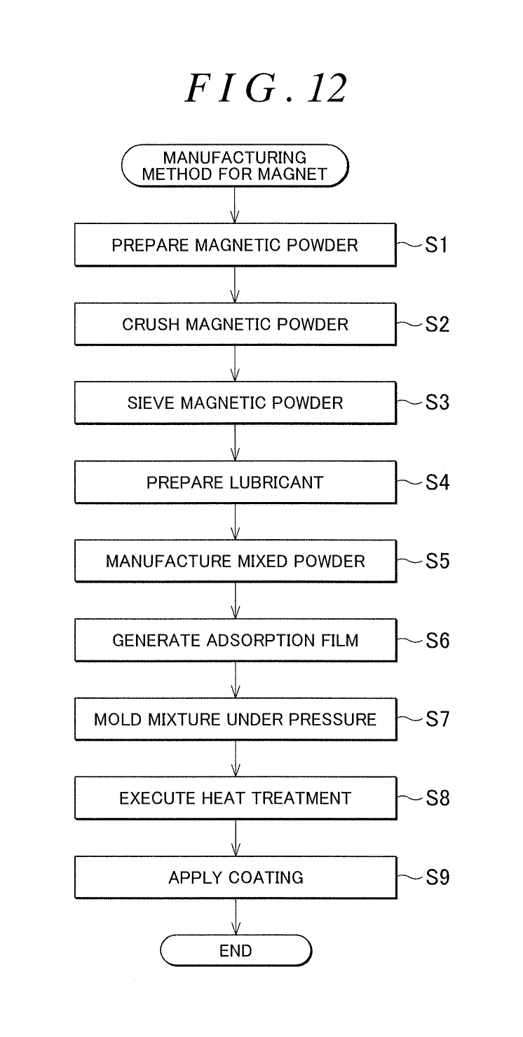

A manufacturing method for a magnet as a third embodiment of the invention will be described with reference to FIG. 12. FIG. 12 is a chart illustrating steps of the manufacturing method for a magnet in the present embodiment.

As illustrated in step Si in FIG. 12, the magnetic powder 1 as a raw material for a magnet is prepared. The present step is similar to step Si in the first embodiment.
As illustrated in step S2 in FIG. 12, the magnetic powder 1 is pressurized and crushed. The present step is similar to step S2 in the first embodiment.

Specifically, the pressurizing roller 7 (71, 72) is used to pressurize (press) the magnetic powder 1 at a pressure equal to or higher than the burst pressure at which the magnetic powder 1 is destroyed. The pressure applied in the present embodiment is also 1 to 3 GPa.

In the present embodiment as well, the pressurization with the pressurizing roller 7 destroys the particles of the magnetic powder 1. In this case, one particle (first particle) of the magnetic powder 1 transmits a load to another magnetic particle (second particle) to destroy the second particle, which is subjected to the load that is equal to or higher than the burst pressure. The second particle is formed into fine crushed particles.

The magnetic powder 1 crushed by the pressurizing roller 7 is disintegrated. The crushed magnetic powder 1 is in a solid state in which the magnetic powder 1 has been compressed by the pressurization with the pressurizing roller 7. The disintegration changes the magnetic powder 1 into fine powder. At this time, primary particles of the magnetic powder 1 are aggregated into secondary particles. The aggregation of the primary particles results from adhesion of fine particles and the effect of a magnetic force of a magnet.

The magnetic powder 1 crushed in step S2 has an average particle size (D50) of 1.8 to 4.0 The average particle size (D50) of the primary particles of the magnetic powder 1 can be measured by a well-known measuring method.

As illustrated in step S3 in FIG. 12, the crushed magnetic powder 1 is sieved. The present step is similar to step S3 in the first embodiment.

The sieving is performed by passing the crushed magnetic powder 1 through a sieve with a predetermined mesh opening. The sieving is performed using a sieve with through-holes that allow intended particles to be obtained.

The present embodiment uses the sieve for sieving of the magnetic powder. However, the invention is not limited to the sieve, and any method or apparatus can be used as long as the method or apparatus allows predetermined particles to be separated from the other particles. For example, particles with large particle sizes may be separated from the other particles using a classify apparatus such as an air sifter.

As described above, the magnetic powder 1 crushed in step S2 is formed into secondary particles. In step S3, the crushed magnetic powder 1 is sieved. That is, the magnetic powder 1 in the form of the secondary particles is sieved.
For the magnetic powder 1 sieved in step S3, the ratio of the average particle size (D50) of the primary particles to the maximum particle size of the secondary particles ranges from 1:150 to 1:200.

The ratio between the primary and secondary particles of the magnetic powder 1 falling within the above-described range reduces voids between the secondary particles. The reduced voids between the secondary particles enable a reduction in the amount of voids remaining in a molding resulting from pressurization of the magnetic powder 1 in a later pressurizing step (step S8). Accordingly, a magnet into which the molding is formed also has reduced voids and is thus dense.

When the consequent of the ratio is less than 150 and thus the ratio between the primary and secondary particles of the magnetic powder 1 falls outside the above range, moldability in pressurization is deteriorated. Specifically, the particle size of the secondary particles is excessively reduced to increase the number of secondary particles and the number of contact points between the secondary particles, leading to an increased apparent volume (increased volume) of the magnetic powder 1. During pressurization performed to form a molding, a large number of contact points are present between the secondary particles, which makes compression of the magnetic powder difficult.

When the consequent of the ratio is more than 200 and thus the ratio between the primary and secondary particles of the magnetic powder 1 falls outside the above range, voids remain in the molding (magnet). Specifically, the ratio falling outside the above range (the consequent is more than 200) causes secondary particles with larger particle sizes to be contained in the magnetic powder 1. This makes voids likely to remain between the secondary particles with large particle sizes. As a result, the voids remain in the molding resulting from pressurization of the magnetic powder 1.

The maximum particle size of the secondary particles of the magnetic powder 1 can be determined based on the mesh opening of the sieve used for sieving. In step S3, the secondary particles are sorted out using a sieve (30 mesh) with a mesh opening of 500 μm, and have a maximum particle size of 500 μm.

As illustrated in step S4 in FIG. 12, the lubricant 2 is prepared. The present step is similar to step S4 in the first embodiment.

As illustrated in step S5 in FIG. 12, the magnetic powder 1 and the lubricant 2 prepared in the above-described two steps are mixed together into mixed powder. The present step is similar to step S5 in the first embodiment.
As illustrated in step S6 in FIG. 12, the mixed powder 1, 2 is heated to form the adsorption film 3 on the surface of the magnetic powder 1. The present step is similar to step S6 in the first embodiment.
As illustrated in step S7 in FIG. 12, the magnetic powder 1 is pressurized into a molding 5. The present step is similar to step S8 in the first embodiment.

As illustrated in step S8 in FIG. 12, the molding 5 is heated in an oxidizing atmosphere to form a secondary molding (heat treatment step).

When the molding 5 is thermally treated in the oxidizing atmosphere, exposed surfaces of the particles of the magnetic powder 1 react with oxygen to form an oxide film on the surface of the magnetic powder 1. The oxide film joins the surfaces of the adjacent particles of the magnetic powder 1. In other words, the oxide film is formed on a part of the magnetic powder 1 that is exposed to the clearance, whereas a part of the magnetic powder 1 that is not exposed to the clearance is a base material itself (an interface where the particles are in pressure contact with each other). Therefore, the oxide film is not formed on all over the surface of the magnetic powder 1.

The secondary molding thus formed may have a sufficient strength. This enables an increase in rupture strength of the secondary molding. The molding 5 has a reduced area where the magnetic powder 1 is not present, and thus, the secondary molding resulting from the heat treatment step has an increased residual magnetic flux density.

The secondary molding has a density of approximately 5 to 6 g/cm³.

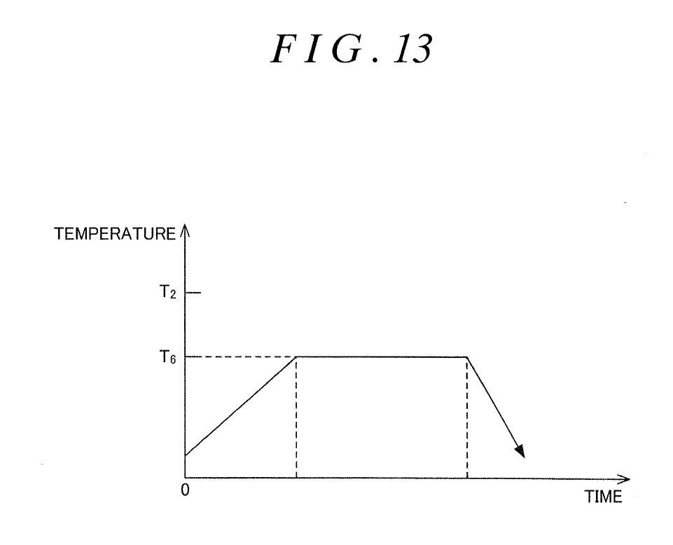

In the heat treatment step, a primary molding is placed in a microwave heating furnace, an electric furnace, a plasma heating furnace, an induction hardening furnace, a heating furnace using an infrared heater, or the like. The heating in the heat treatment step is not limited but may go through, for example, a variation in temperature illustrated in FIG. 13.

As illustrated in FIG. 13, the heating temperature T6 is set lower than the decomposition temperature T2 of the magnetic powder 1. For example, when Sm₂Fe₁₇N₃ or Fe₁₆N₂ is used as the magnetic powder 1, the decomposition temperature T2 is approximately 500° C., and thus, the heating temperature T6 is set lower than 500° C. For example, the heating temperature T6 in the present step is approximately 200 to 300° C.

An oxygen concentration and an atmospheric pressure in the oxidizing atmosphere may be set to any values as long as the oxygen concentration and the atmosphere pressure allow the magnetic powder 1 to be oxidized. The oxygen concentration and the atmospheric pressure may adequately be approximately equal to the oxygen concentration in the air and the air pressure, respectively. Therefore, the oxygen concentration, the atmospheric pressure, and the like need not specially be controlled. Thus, the magnetic powder 1 may be heated in an air atmosphere. Setting the heating temperature T6 to approximately 200 to 300° C. allows forming an oxide film regardless of whether the magnetic powder is Sm₂Fe₁₇N₃ or Fe₁₆N₂.

As illustrated in step S9 in FIG. 12, the secondary molding formed in the heat treatment step is treated so as to cover the surface of the secondary molding with a coating film to obtain the magnet 6 in the present embodiment.

Examples of the coating film include a plating film formed by electroplating of Cr, Zn, Ni, Ag, Cu, or the like, a plating film formed by electroless plating, a resin film formed by resin coating, a glass film formed by glass coating, and a film of Ti, diamond like carbon (DLC) or the like. An example of the electroless plating is electroless plating using Ni, Au, Ag, Cu, Sn, Co, or an alloy or a mixture thereof. An example of the resin coating is coating with a silicone resin, a fluorine resin, a urethane resin, or the like.

In other words, the coating film functions like an egg shell. Thus, the rupture strength of the magnet 6 can be increased by a joining force exerted by the oxide film and the coating film. In particular, the electroless plating enables surface hardness and adhesion to be enhanced, allowing the joining force of the magnetic powder 1 to be made stronger. For example, electroless nickel phosphorous plating also improves corrosion resistance.

As described above, the oxide film joins the particles of the magnetic powder 1 together not only on the surface of the secondary molding but also the inside of the secondary molding. Therefore, the joining force exerted by the oxide film restricts free movement of the particles of the magnetic powder 1 inside the magnet 6. This allows suppression of inversion of magnetic polarities resulting from rotation of the magnetic powder 1. In other words, a high residual magnetic flux density can be achieved.

When the electroplating is applied in the coating step, the unplated secondary molding acts as an electrode and thus needs to have a high joining strength. However, when the electroless plating, the resin coating, or the glass coating is applied in the coating step, the joining strength of the secondary molding need not be high as in the case of the electroplating. In other words, the joining force exerted by the oxide film is sufficient. Therefore, the above-described coating step allows the coating film to be reliably formed on the surface of the secondary molding.

When the electroless plating is applied in the coating step, the secondary molding is impregnated with a plating solution. At this time, the plating solution acts to enter the interior of the secondary molding, but the oxide film formed effectively suppresses the entry of the plating solution. In other words, the oxide film is expected to suppress corrosion of the secondary molding and the like resulting from the entry of the plating solution into the secondary molding.

Like the first embodiment, the present embodiment allows a dense molding 5 to be obtained. Accordingly, it is possible to obtain a dense magnet 6 from the dense molding 5.

That is, the magnet 6 manufactured by a manufacturing method not using the binder 4 as in the present embodiment is effective for obtaining a dense magnet 6 as is the case with the first embodiment. That is, it is found that the manufacturing method in which the magnetic powder 1 is pressurized to form a molding 5 allows obtaining a dense molding 5 and a dense magnet 6 by controlling the particle characteristic of the primary and secondary particles of the magnetic powder 1.

What is claimed is:

1. A manufacturing method for a magnet, comprising:
molding, under pressure, magnetic powder in a form of secondary particles resulting from aggregation of primary particles, to obtain a molding, wherein
the magnetic powder is configured such that a ratio of an average particle size of the primary particles to a maximum particle size of the secondary particles is 1:150 to 1:200.

2. The manufacturing method for a magnet according to claim 1, wherein
the magnetic powder is obtained by pressurizing magnetic powder having a larger particle size than the primary particles at a pressure equal to or higher than a burst pressure to destroy the magnetic powder and to form the secondary particles.

3. The manufacturing method for a magnet according to claim 1, wherein a maximum particle size of the secondary particles is controlled by classification.

4. The manufacturing method for a magnet according to claim 2, wherein a maximum particle size of the secondary particles is controlled by classification.

5. A magnet manufactured by the manufacturing method for a magnet according to claim 1.
